(19) United States
(12) Patent Application Publication
(10) Pub. No.: US 2012/0176649 A1
(43) Pub. Date: Jul. 12, 2012

(54) System and Method for Printing Advertisements on Parcel Packages in an Automated Parcel Distribution System

(76) Inventors: Jeff Giordano, Norwalk, CT (US); Jeff Jensen, Norwalk, CT (US); James Ho, El Segundo, CA (US)

(21) Appl. No.: 13/425,902

(22) Filed: Mar. 21, 2012

Related U.S. Application Data
(63) Continuation-in-part of application No. 13/183,277, filed on Jul. 14, 2011.
Application No. 13/183,277 is a continuation-in-part of application No. 11/461,622, filed on Aug. 1, 2006.
Application No. 11/461,622 is a continuation-in-part of application No. 11/423,692, filed on Jun. 12, 2006.

(51) Int. Cl. G06K 15/02; G06Q 30/02

(52) U.S. Cl. 358/1.18

(57) ABSTRACT

A method for placing targeted advertisements on parcel packages moving on a conveyor. The method includes electronically scanning, via a processing device, information regarding one or more packages to be delivered to one or more recipients. Promotion data regarding one or more promotions targeted to the one or more recipients is retrieved. An arrival time for the one or more packages to arrive at a print station is determined based on a rate at which the one or more packages are moving on the conveyor. The promotion data is spooled to the print station at a spool time based on the arrival time. The one or more promotion labels associated with the promotion data are applied on the one or more packages at the print station in synchronization with the package movement rate.

### CLAIM OF PRIORITY

This application is a Continuation-In-Part of and claims priority to U.S. application Ser. No. 13/183,277, filed on Jul. 14, 2011, which claims priority to U.S. application Ser. No. 11/461,622, filed on Aug. 1, 2006, which claims priority to U.S. application Ser. No. 11/423,692, filed on Jun. 12, 2006. These disclosures are hereby incorporated by reference herein in their entireties.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This application generally relates to the field of printing targeted advertising, and in particular, to printing targeted advertisements on parcel packages in an automated parcel distribution environment.

### BACKGROUND OF THE INVENTION

Advertisers place promotions or other advertisement in locations where they are viewed (and hopefully absorbed) by other persons or entities. These locations can be both physical and/or virtual (i.e., off-line and/or on-line). For example, such locations include television, newspapers, magazines, and the Internet. These advertisements or promotions can be directed regionally, according to cities, counties, states, or countries in which they are placed.

Additionally, a wide variety of different mediums may be utilized for advertising. Advertisers choose specific mediums and locations for the placement of their advertisements in order to attempt to expose the advertisement to an intended audience. For example, a marketer of female cosmetics may choose to build awareness for a new line of female cosmetics by placing an advertisement in a magazine that has a large readership of females.

Various methods of advertising and/or promoting have associated advantages and drawbacks. Thus, advertisers are often inclined to pay professional advertising organizations, entities, and individuals to target and dispense their advertisements, as they seek more effective mediums, locations, and techniques for targeting, placing, and measuring the effectiveness of promotions. The advertisements and/or promotions that are suggested or used by these entities typically include expensive media or printed materials that have high distribution costs associated with them. Even Internet-based promotions, which tend to be quite efficient, still have high costs associated with them, since popular web sites often charge a premium on a per-impression basis for placing banners or links on their web pages. Further, while Internet use has increased, it is desirable to provide a form of promotional advertisement that is more readily viewed by the consuming public without having to log on to a computer.

The assignee of the present application described in previous applications, methods and systems for providing targeted advertisement on a package to be delivered to a recipient. Advertisement information is received from an advertiser that includes one or more advertisements that the advertiser desires to be placed. An advertisement for the package is either selected or created in response to analyzing the advertisement, package characteristics, and recipient characteristics. The advertisement is then placed on the package for delivery. Accordingly, the present application provides for further improvements to the methods and systems for providing targeted advertisements on packages including more efficient processes for a large warehouse setting and automation of the advertisements placed on the packages for delivery. In addition, the present application enables the application of color-printed advertisements on packages in an automated environment.

### SUMMARY OF THE INVENTION

The present application provides a method and system for placing targeted advertisements on parcel packages moving on a conveyor. The method includes electronically scanning, via a processing device, information regarding one or more packages to be delivered to one or more recipients. Promotion data regarding one or more promotions targeted to the one or more recipients is retrieved. An arrival time for the one or more packages to arrive at a print station is determined based on a rate at which the one or more packages are moving on the conveyor. The promotion data is spooled to the print station at a spool time based on the arrival time. The method further includes applying one or more promotion labels associated with the promotion data on the one or more packages at the print station in synchronization with the package movement rate.

The method may further include synchronizing the print station with the package movement rate. The print station may include a high-speed printer. According to some embodiments, the print station includes a Memjet printer. The printing speed of the print station may also be synchronized with the package movement rate. In another embodiment, the method may include synchronizing the conveyor's speed with printing speed of the print station. The one or more promotion labels may be printed in black and white, or in color. The spool time in which the promotion data is spooled to the print station is before the arrival time.

According to another aspect of the present application, the method includes electronically scanning, via a processing device, information regarding a package to be delivered to a recipient. The promotion data targeted to the recipient is retrieved. A given print station suitable for generating a promotion label associated with the promotion data is selected. An arrival time for the package to arrive at the given print station is determined based on a rate at which the package is moving on the conveyor. The promotion data is spooled to the given print station at a spool time based on the arrival time. The one or more promotion labels are applied on the package at the given print station in synchronization with the package movement rate.

Selecting the given print station may include determining a suitable print station based on at least one of: capabilities of print stations, promotion data batch, size of a print job associated with the promotion data, type of print job associated with the promotion data, and time required to spool the promotion data.

### BRIEF DESCRIPTION OF THE DRAWINGS

The invention(s) is/are illustrated in the figures of the accompanying drawings which are meant to be exemplary and not limiting, in which like references are intended to refer to like or corresponding parts, and in which:

FIG. 1 illustrates a diagram of a system for providing targeted advertising on parcel packages according to one embodiment.

FIG. 2 illustrates a component diagram of a system for providing targeted advertising on parcel packages according to one embodiment.

FIG. 3 illustrates a block diagram of a parcel targeted advertising system according to one embodiment.

FIG. 4 illustrates a perspective view of a package that includes a promotion label, in accordance with one embodiment.

FIG. 5 illustrates a promotion label according to one embodiment.

FIG. 6 illustrates an invoice with a promotion label according to one embodiment.

FIG. 7 illustrates a flowchart of a method for obtaining a promotion for a package according to one embodiment.

FIG. 8 illustrates a component diagram of a system for placing advertisements on parcel packages according to one embodiment.

FIG. 9 illustrates a diagram of a system for placing advertisements on parcel packages according to one embodiment.

FIG. 10 illustrates a flowchart of a method for placing advertisements on parcel packages according to one embodiment.

FIG. 11 illustrates a component diagram of a system for placing advertisements on parcel packages according to another embodiment.

FIG. 12 illustrates a flowchart of a method for selecting print stations for placing advertisements on parcel packages according to one embodiment.

### DETAILED DESCRIPTION OF THE INVENTION

In the following description of the embodiments of the invention(s), reference is made to the accompanying drawings that form a part hereof, and in which is shown by way of illustration, exemplary embodiments in which the invention(s) may be practiced. It is to be understood that other embodiments may be utilized and structural changes may be made without departing from the scope of the present invention(s).

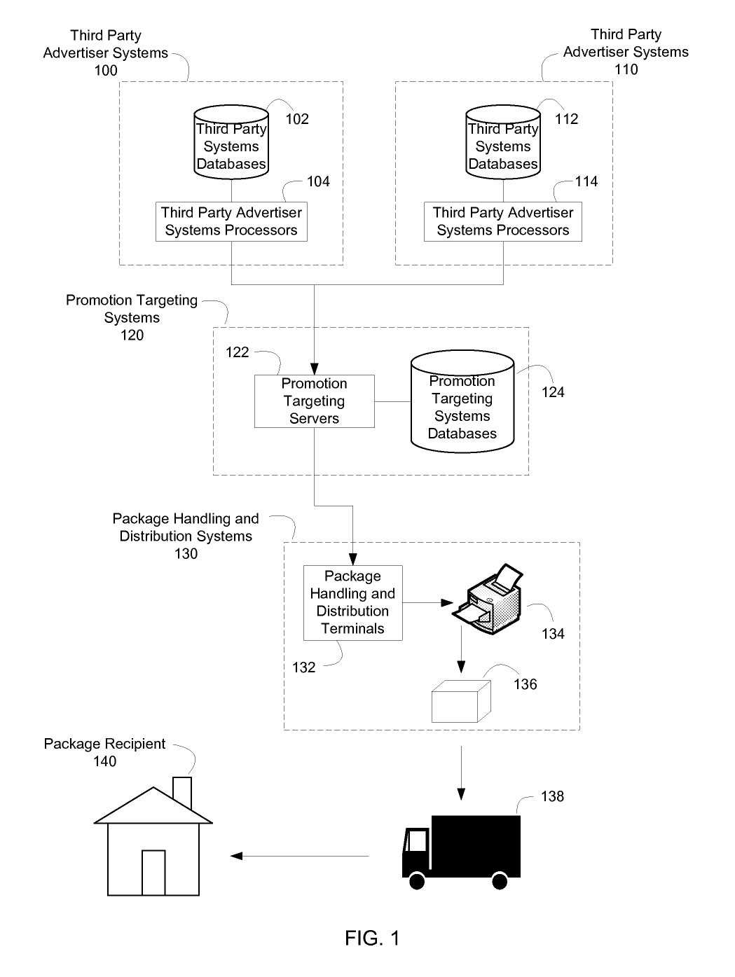

FIG. 1 presents a system for providing targeted advertising on delivered parcel packages according to an embodiment of the systems discussed herein. The system includes third party advertiser systems 100, third party advertiser systems 110, promotion targeting systems 120, package handling and distribution systems 130, logistics 138, and package recipient 140.

Each of third party advertiser systems 100 and 110 may include third party systems databases 102, 112 and third party advertiser systems processors 104, 114. Third party advertiser systems 100 and third party advertiser systems 110 may represent two advertisers wishing to promote and advertise certain products or services. Third party advertiser systems 100 and 110 may use third party advertiser systems processors 104 and 114 to create or retrieve targeted offers, advertisements or promotions. Targeted offers may include offers directed to certain consumers, such as package recipients that have purchased certain goods to be delivered.

Frequently, advertisers desire to target their promotions to the specific demographics of users. For example, and not by way of limitation, targeted demographic selections may include: gender, household income, age, geographic region, or language. Additionally, some advertisers may desire to further target their promotions to specific individuals who meet particular parameters. In this regard, “targeting” is a technique that advertisers use to attempt to increase the effectiveness of an advertisement. Targeting allows advertisements to be directed or focused towards specific individuals or groups who are likely to be interested in, or influenced by, the advertisement. Through the use of targeted advertising, an advertiser may reduce the expense of disseminating advertisements to uninterested parties. In this manner, the overall effectiveness and efficiency of an advertising campaign can be increased due to the reduction in cost from decreased dissemination of advertisements to uninterested parties.

Targeted offers may be stored and indexed in third party systems databases 102 and 112 for retrieval. Third party advertiser systems 100 and 110 may be advertising clients of promotion targeting systems 120. In one embodiment, third party advertisers may pay certain fees in exchange for distribution of the targeted offers or promotions by promotion targeting systems 120. Fees may be paid on the basis of an amount of promotions sold and printed.

Promotion targeting systems 120 includes promotion targeting servers 122 and promotion targeting systems databases 124. Promotion targeting servers 122 may receive targeted promotions from third party advertiser systems 100 and 110. The targeted promotions received from the third party advertiser systems may be associated with certain advertising parameters provided by the third party advertiser systems. The advertising parameters, for example, may be an intended target audience. The targeted promotions and the advertising parameters may be stored and indexed in promotion targeting systems databases 124. Promotions stored in promotion targeting systems databases 124 may be selected and retrieved for transmission to package handling and distribution systems 130.

Package handling and distribution systems 130 include package handling and distribution terminals 132, printer 134 and package 136. Package handling and distribution systems 130 may be at a location where a business ships products from its warehouses to customers. The business may establish a partnership with promotion targeting systems 120 to receive revenue from promotion targeting systems 120 in exchange for placing promotions specified by the promotion targeting systems on outgoing packages. Package handling and distribution terminals 132 may be used to view, manage, and print promotion labels on printer 134. Terminals may comprise a desktop personal computer, workstation, laptop, personal digital assistant (PDA), cell phone, or any computing device capable of connecting to a network. The terminals may also comprise a graphical user interface (GUI) or a browser application provided on a display (e.g., monitor screen, LCD or LED display, projector, etc.).

Promotion targeting servers 122 may determine a targeted promotion suitable for a package 136. As used herein, a package refers to any type of container or other storage vessels that are rectangular, cylindrical, or otherwise shaped. Package 136 may correspond to a package recipient 140. On the basis of information associated with the package recipient 140, promotion targeting servers 122 may determine an appropriate promotion for package recipient 140. The information associated with package recipient 140 may include a recipient name, recipient address, product information (e.g., a stock-keeping unit (SKU) number), product category, etc. Promotion targeting servers 122 may use various geographic, demographic, socio-economic and purchasing behavior factors to determine an appropriate promotion for package recipient 140.

Targeted promotions may be printed on color labels and placed on packages being shipped to consumers from package handling and distribution systems 130. Package handling and distribution systems may be paid guaranteed fees to place promotions on their outgoing package box location or “real estate.” In an alternative embodiment, package handling and distribution systems 130 may use this customer touch-point to deliver their own offers that up-sell, cross-sell, or drive consumers to a web site or retail location. Third party advertisers may pay for each promotion that is printed and placed on an outgoing package.

Promotions may be approved or disapproved by package handling and distribution systems 130. Promotion targeting systems 120 may provide objectionable promotions or promotions that may conflict with the business practices of package handling and distribution systems 130. Approved promotions may be indexed and hosted by promotion targeting servers 122. The hosted promotions may be accessed by package handling and distribution systems 130 via a user interface to promotion targeting systems 120 for printing of the promotions at a package handling and distribution system location. According to one embodiment, promotions may be downloaded and cached at package handling and distribution system for later retrieval and printing. Equipment used to access and print the promotions may include hardware and software provided by the promotion targeting systems. In an alternative embodiment, package handling and distribution systems 130 may use existing equipment present in their location to access and print the promotions hosted by promotion targeting systems 120.

The printed promotions may include high resolution promotions in the form of labels. The promotion labels may be printed on demand and produce color or black and white labels of varying dimensions with personalized offers that are applied to outgoing packages. The promotion labels may be offered to parcels being shipped from package handling and distribution systems 130 to the consumers. Promotion labels printed and placed on the parcel packages may be highly targeted and personalized to the individual customers or recipients. The promotions contained on the labels may be relevant as they can be micro-targeted to individual consumers. Placing promotions on packages may engage consumers as the promotions may anticipate the reveal of a recent purchase, especially if the promotions have been selected for inclusion on the package based on the contents in the package. Packages ready for shipment may be delivery by logistics 138 to a package recipient 140. Package recipient 140 may receive the package with valuable promotional offers on the packaging. As a result, the printed promotions may drive retail sales and direct consumer sales.

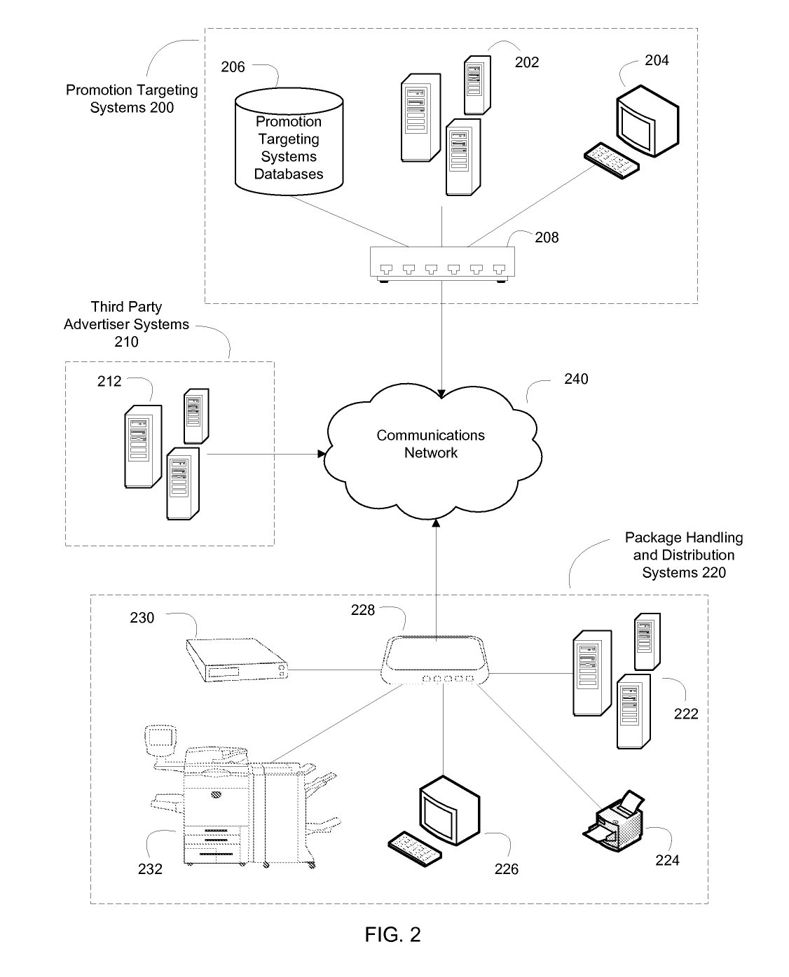

FIG. 2 presents a system for providing targeted advertising on delivered parcel packages according to one embodiment. The system includes promotion targeting systems 200, third party advertiser systems 210, package handling and distribution systems 220 and communications network 240.

Promotion targeting systems 200 also includes promotion targeting systems servers 202, promotion targeting systems terminal 204, promotion targeting systems databases 206 and switch 208. Promotion targeting systems servers 202 may receive targeted promotions from third party advertiser systems servers 212 via communications network 240. The targeted promotions may be stored and later retrieved from promotion targeting systems databases 206 by promotion targeting systems servers 202. Promotion targeting systems servers 202 may also include processing devices and logic to determine appropriate promotions for each package recipient. Determination of appropriate promotions may include decision analysis using decision trees, graphs or models. The decision analysis may be used to retrieve promotions based information including geographic, demographic, and/or behavioral data of a user for targeting, including previous and then current purchases. Such information of the user may be supplied by the promotion targeting systems 200 or from the package handling and distribution systems 220. Promotion targeting systems terminal 204 is operable to manage, view and edit the decision analysis and targeted promotions.

Switch 208 provides for the facilitation of data and communication between the various components in promotion targeting systems 200 with third party advertiser systems 210 and package handling and distribution systems 220 through communications network 240. Communications network 240 may be any suitable type of network allowing transport of data communications across thereof. In one embodiment, the network may be the Internet, following known Internet protocols for data communication, or any other communication network, e.g., any local area network (LAN), or wide area network (WAN) connection.

Package handling and distribution systems 220 may include package handling and distribution systems servers 222, warehouse printer 224, package handling and distribution systems terminal 226, switch 228, promotion targeting systems appliance 230, and promotion printer 232. Package handling and distribution systems servers 222 may include hardware and software operable to perform processing of orders, shipping information, inventory, invoices, and other warehouse management operations of the package handling and distribution systems. Warehouse printer 224 may print invoices and labels. Promotion labels may be printed from promotion printer 232. Promotion labels are not limited to being printed from promotion printer 232. In an alternative embodiment, printer 224 or any off the shelf printer may be used to print promotion labels received from promotion targeting systems 200. For example, smaller printers residing at individual packing stations within a warehouse at package handling and distribution systems 220 may be used to print promotion labels.

Package handling and distribution systems terminal 226 may be operable to access and provide an interface to manage the orders, shipping information, inventory, invoices and other warehouse management operations. In addition, terminal 226 may also be able to access, manage, view and print promotion labels received from promotion targeting systems 200. Promotion targeting systems appliance 230 may include a controller and/or storage device for providing a kiosk interface and managing printing from promotion printer 232. Appliance 230 may be used to create print jobs for printing batches of promotion labels. Appliance 230 or servers 222 may also store targeted promotion image files received from promotion targeting systems 200. Switch 228 provides for the facilitation of data and communication between the various components in package handling and distribution systems 220 and promotion targeting systems 200 through communications network 240.

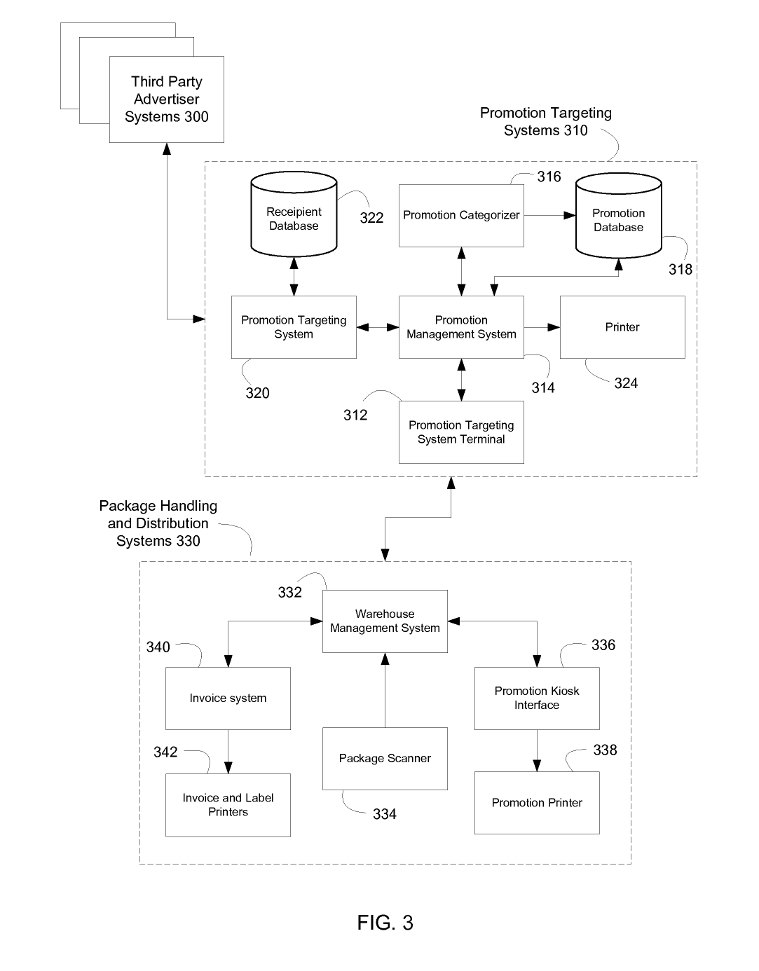

According to an alternative embodiment, pre-printed promotion labels may be printed at promotion targeting systems 200 (described in further detail below regarding FIG. 3) and delivered physically to the facilities of package handling and distribution systems 220. The pre-printed promotion labels may be affixed to outgoing packages “as is” or fed into either printer 224 or 232 for printing of further detail or information on the pre-printed promotion labels. Pre-printed promotion labels may serve as template promotion labels providing all the basic promotion information but require printing of further specific details at package handling and distribution systems 220. Further details may include consumer name, promotion dates, or any other information that is determined upon shipping of a package. Promotion targeting systems 200 may provide package handling and distribution systems 220 with a variety of pre-printed promotion labels from various third party advertisers. In one embodiment, packages may be scanned at package handling and distribution systems 220 to transmit package information, e.g., regarding package contents, to promotion targeting systems 200, wherein upon receiving the package information, promotion targeting systems 200 may specify to match, collate and affix specific pre-printed promotion labels to outgoing packages. The specified pre-printed promotion labels may either be further printed with personalized information (e.g., a consumer's name) or placed on a package “as is.” In yet another embodiment, promotion targeting systems 200 may digitally transmit template promotion labels to package handling and distribution systems 220 for addition of personalized information similar to template pre-printed promotion labels.

FIG. 3 presents a parcel targeted advertising system according to one embodiment. The advertising system includes third party advertiser systems 300, promotion targeting systems 310 and package handling and distribution systems 330.

Promotion targeting systems 310 also includes promotion targeting system terminal 312, promotion management system 314, promotion categorizer 316, promotion database 318, promotion targeting system 320, recipient database 322 and printer 324. Promotion targeting systems 310 may receive targeted promotions from a plurality of third party advertiser systems 300. The targeted promotions may be analyzed by promotion management system 314 and indexed into promotion database 318 by promotion categorizer 316. Promotion targeting system terminal may be used to view and manage operation of the promotion management system 314. Promotion targeting systems 310 may also receive a promotion request from package handling and distribution systems 330. The promotion request may be received from warehouse management system 332 upon scanning package information. Packages or orders may be scanned at package handling and distribution systems 330 using package scanner 334 at a warehouse kiosk. The packages may be scanned using any of barcode, Radio-frequency Identification (RFID) or any other technology using a reader and tag. Scanning may include any form of information capture used to collect various attributes associated with the one or more packages. In an alternative embodiment, scanning may be performed at individual printer kiosks and/or individual packing stations. A job request may be initiated by sending the parcel information to promotion targeting systems 310.

Promotion requests may be received by promotion management system 314 to determine an appropriate promotion for each request. The package information may include information identifying the recipient of the package. Identification of the recipient may be forwarded to promotion targeting system 320 to match a targeted and personalized promotion with the recipient. Promotion targeting system 320 may include software, logic or hardware to segment individual consumers into actionable groups defined by marketers. The actionable groups may be based on geographic, demographic, socio-economic and purchasing behavior factors. For example, a given promotion may be targeted to recipients living in certain geographic regions. Methods for matching a targeted advertisement with a recipient may include the use of decision trees or other matching algorithms known by one of ordinary skill in the art and a weighting system such as the one described in commonly owned U.S. Patent Publication No. 2008/0010115 entitled “PARCEL ADVERTISING SYSTEM AND METHOD,” the disclosure of which is hereby incorporated by reference in its entirety.

Geographic, demographic, socio-economic and purchasing behavior information of recipients may be stored in recipient database 322. Recipient information stored in database 322 may be gathered from user profiles generated by promotion targeting system 320 or from information provided by package handling and distribution systems 330. Promotion management system 314 may identify a targeted promotion matched by promotion targeting system 320 and record the package with the matching promotion on a list. The list may be loaded on promotion management system 314 and accessed by promotion kiosk interface 336 for retrieval of promotions from promotion database 318.

Promotion kiosk interface 336 may include an interface to promotion management system 314 for viewing, managing, and printing promotion labels on promotion printer 338. Promotion labels available for printing may be selected and transmitted to kiosk interface 336 for printing on promotion printer 338. In one embodiment, a plurality of promotion labels for packages may be batched in “waves.” Waves of packages may be determined by time, quantity of job requests, recipients, etc. For each package and promotion label belonging to a wave, a subset of sequence numbers may be assigned to items belonging to the wave. In wave printing, a promotion label may be printed, matched and collated with each package invoice, providing every package in the warehouse with a promotion label. In an alternative embodiment, labels may be printed on demand for selective invoices or packages at individual packing stations. In certain embodiments, printer 324 in promotion targeting systems 310 provides for printing of pre-printed promotion labels. A variety of pre-printed promotion labels from third party advertisers may be printed at promotion targeting systems 310 to alleviate printing duties at package handling and distribution systems 330. The pre-printed promotion labels can be delivered to a package handling and distribution systems location for placement on future outgoing shipments.

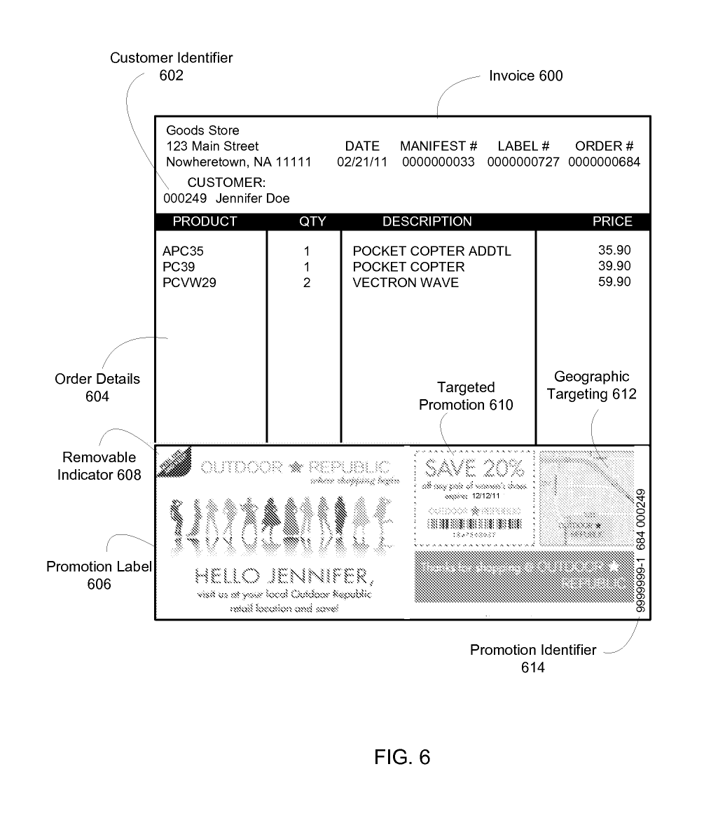

Package handling and distribution systems 330 also includes invoice system 340 coupled to warehouse management system 332. Invoice system 340 generates invoices for orders placed on outgoing packages. Invoices and shipping labels may be printed on invoice and label printers 342. In some embodiments, invoice and label printers may also print promotion labels individually or on the same form, alongside with the invoices or shipping labels to ensure that the correct targeted promotion is affixed to the correct outgoing shipment or package, which is described in further detail below regarding FIG. 6.

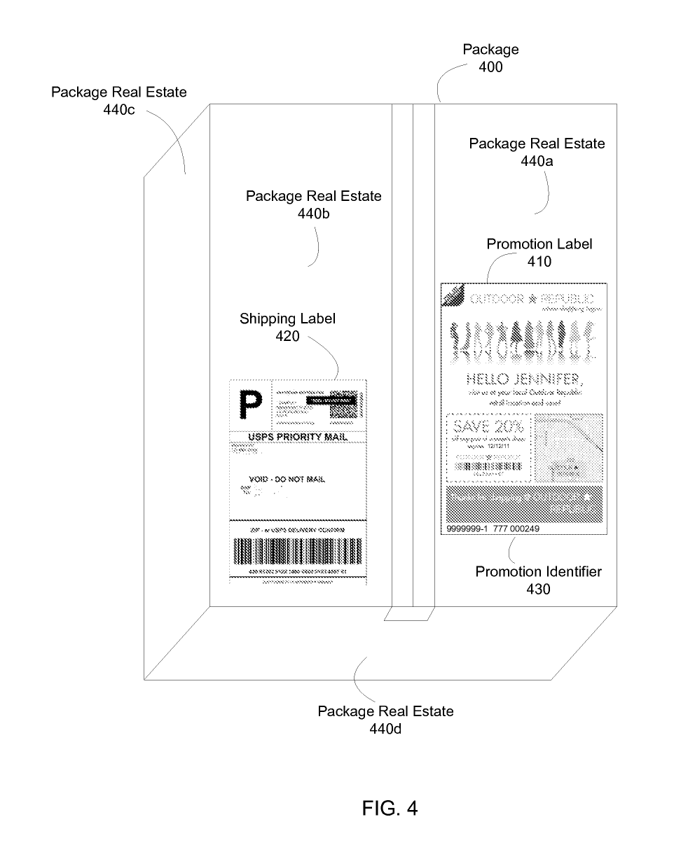

FIG. 4 illustrates a package 400 including a promotion label 410 placed next to a shipping label 420. Promotion label 410 includes a promotion identifier 430 that may correspond to a recipient, invoice, order, package or shipment identifier assigned by a warehouse management system. The promotion identifier 430 may serve to specify a particular parcel package to place the promotion label on. Often times, this identifier is printed on a pack slip, invoice form or shipping label. Promotion identifier 430 may be assigned any number, series or sequence number defined by the package handling and distribution systems or the promotion targeting systems.

Similar to web pages possessing advertising space, a parcel may include package “real estate.” As illustrated, promotion label 410 is placed at package real estate 440a (right flap of the box) and shipping label 420 is placed at package real estate 440b (left flap of the box). Other (non-exhaustive) examples of package real estate may include 440c and 440d. In most cases, package real estate 440a and 440b are considered “prime” package real estate given their prominent location on the package that guarantees a noticeable display to a recipient of the package. Meanwhile, package real estate 440c and 440d may be lesser desirable locations to place a promotion label. According to one embodiment, any one of third party advertiser systems, promotion targeting systems or package handling and distribution systems may specify where a given printed promotion should be placed on a package. In another embodiment, any number of promotion labels may be placed on a given package.

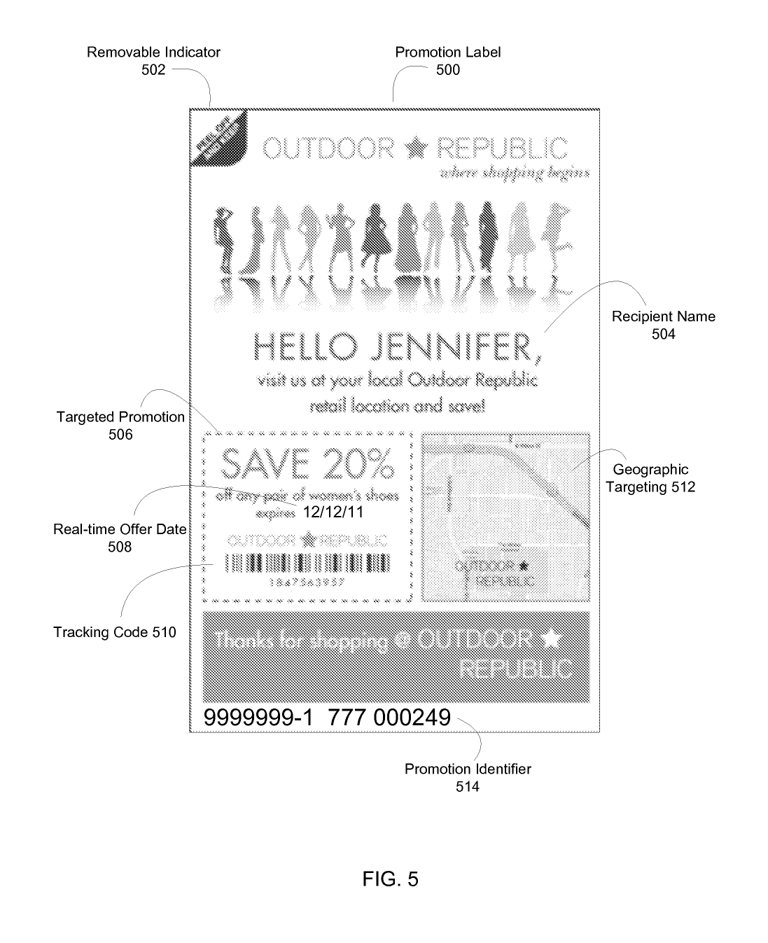

FIG. 5 presents a promotion label 500 according to one embodiment. Promotion label 500 includes removable indicator 502, recipient name 504, targeted promotion 506, real-time offer date 508, tracking code 510, geographic targeting 512, and promotion identifier 514. Often times, a regular label can be difficult to remove without damaging the label. Removable indicator 502 allows a recipient of a package with a promotion label, such as the one illustrated in this figure, to easily peel the promotion label from the adhesive backing of the label for safekeeping. Promotion label 500 also includes recipient name 504, which creates a sense of personalization on the promotion label, and targeted promotion 506 that is based on a recipient's characteristics.

Targeted promotion 506 may be a uniquely generated offer based on the recipient or the recipient's characteristics. In one embodiment, promotion labels from a given third party advertiser may be generated with a common appearance but differ from recipient to recipient. The targeted promotion 506 includes a real-time offer date 508 and tracking code 510. Real-time offer date may be dynamically generated upon creation of the promotion label 500 or targeted promotion 506. Tracking code 510 may be scanned or typed to redeem the targeted promotion 506 either in a brick and mortar retail store or online. In some embodiments, tracking code 510 may also be used to track and confirm receipt and proper affixation of promotion labels to parcel packages.

Promotion identifier 514 corresponds to a recipient, invoice, order, package or shipment identifier to place the promotion label on. Geographic targeting 512 may indicate a targeted region, the recipient's location, a retail location, or the retail location in reference to the recipient's location. In another embodiment, the targeted promotion may be valid only at a retail store indicated by geographic targeting 512. Targeting to recipient characteristics enable marketers to serve relevant advertisements or promotions to individual consumers. FIG. 5 illustrates a specific, non-limiting example of a promotion label and any number of recipient characteristics may be used in creating promotion label 500. In other embodiments, a promotion label may include other forms of advertisement or message delivery such as instantly redeemable coupons (IRCs), die cuts, foils, scents and printing directly on packages.

FIG. 6 presents an invoice 600 according to an embodiment. Invoice 600 includes customer identifier 602, order details 604 and promotion label 606. In this embodiment, a promotion label 606 is integrated with, placed, or printed below an invoice 600. A warehouse printer may be programmed and fed a promotion to be printed on the same form alongside an invoice and/or shipping label. If there happens to be no matching promotions from advertisers for a given package recipient, the integrated form may show a blank promotion label. In another embodiment, the integrated form may be re-sized or truncated if there are no promotions to print. Positioning of the promotion label is not limited to the illustrated configuration and may be placed or printed anywhere on a package or label in conjunction with the invoice 600.

The exemplary invoice 600 shows a customer identifier 602 with a customer's name and order details 604 showing an itemized listing of ordered products. Customer identifier 602 may be used to match a promotion with a promotion identifier 614 to the invoice. In an integrated invoice, the customer identifier 602 may be matched with the promotion identifier 614 by an operator at the warehouse or by a warehouse management system. Promotion label 606 includes removable indicator 608, targeted promotion 610, geographic targeting 612 and promotion identifier 614 similar to the promotion label illustrated in FIG. 5. A recipient may peel promotion label 606 to remove it from the invoice at the removable indicator 608. Targeted promotion 610 may be redeemed by the recipient at a retail store shown by geographic targeting 612 or at other retail locations.

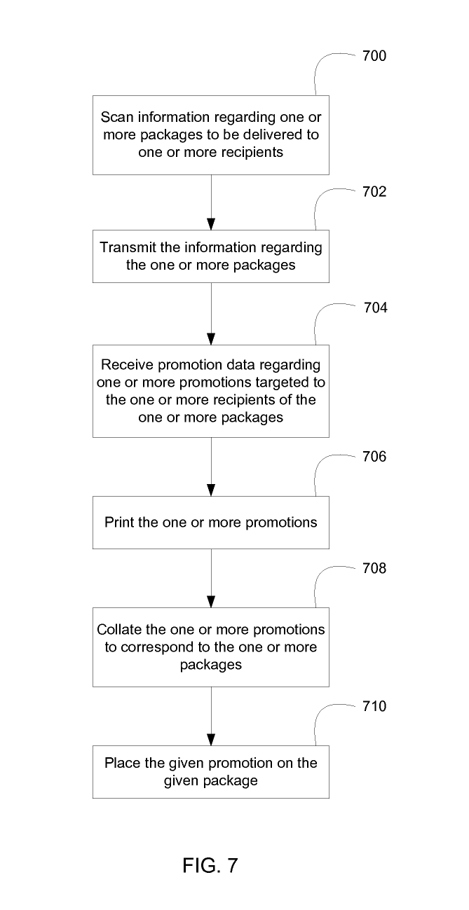

FIG. 7 presents a method for obtaining a promotion for a package according to one embodiment.

In step 700, information regarding one or more packages to be delivered to one or more recipients is scanned, step 700. Scanning may include any form of information capture used to collect various attributes associated with the one or more packages. The information may include data collected at the warehouse or a packing station within the warehouse regarding package recipients including, but not limited to, names and addresses, package contents, etc. This information may be sent to a warehouse management system where the information regarding the one or more packages is transmitted, step 702. The information may be transmitted to a promotion targeting system for the retrieval of promotions. Package information may be transmitted to the promotion targeting system as a XML formatted file (or any other suitably formatted file) from the warehouse management system via FTP (or any other transmission means).

It is noted that in some embodiments, it may be determined that there are no available promotions for some of the scanned packages. There may also be some instances where promotion labels are unavailable for the reason that the transmitted package information may be awaiting processing at the promotion targeting system. Once processing has been completed, promotion targeting system may indicate availability of promotion labels that were previously unavailable. In cases where there are no available promotions even after processing, packages may be shipped without promotion labels. In another embodiment, if a promotion targeting system does not provide a promotion, the package handling and distribution systems may supply their own promotions.

Promotion data regarding one or more promotions targeted to the one or more recipients of the one or more packages are received in step 704. The promotion data may be received and requested from a kiosk interface with the promotion targeting system. The interface may indicate the status or availability of the one or more promotions for one or more packages and provide an option to view and print the one or more promotions. In one embodiment, notifications may be sent to email addresses to indicate promotion label availability. In another embodiment, the interface may provide the option to automatically print promotions as they become available from the promotion targeting system.

A next step 706 includes printing the one or more promotions. The one or more promotions may be printed on promotion labels from one or more printers in a warehouse located at a package handling and distribution system location. The one or more promotions are collated to correspond to the one or more packages in step 708. The promotions may be printed and collated by code or promotion identifiers with each outgoing shipment such that a specific promotion label is matched with a specific package recipient. This may be carried out by pairing up invoices with promotion labels. In one embodiment, each and every outgoing package may be assigned with at least one promotion label. In an alternative embodiment, only selective packages may be scanned or assigned a promotion label. This decision may be made by either the promotion targeting systems or the package handling and distribution systems. Once the given promotion label is matched up with its corresponding package, the given promotion is placed on the given package, step 710.

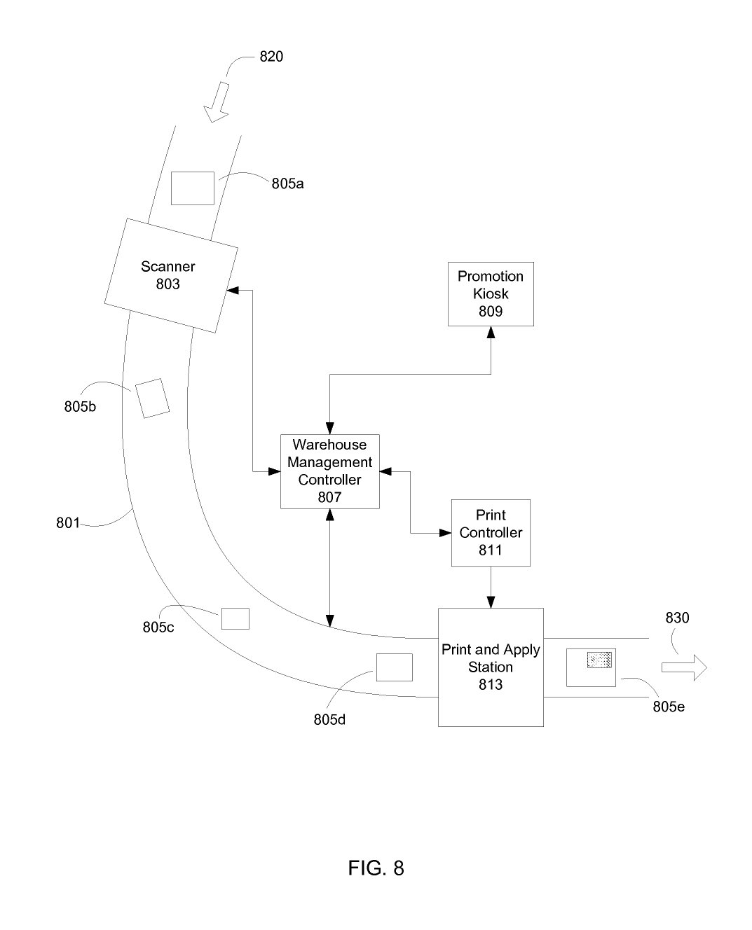

FIG. 8 presents a component diagram of a system for placing advertisements on parcel packages according to one embodiment. The system can be used to apply information to packages on a conveyor 801. Such information is not limited to advertisements or promotions, but may also include, product information, shipping information, machine-readable bar codes, package contents, etc. The information can be applied to a package either after the package has been assembled or, in an alternative embodiment, before it is erected into its final form and size. Applying the information on a package may include stamping, directly printing on, spraying, and attaching a label of the information on the package.

In accordance with one embodiment, the system provides a conveyor 801 configured to receive and transport packages 805a, 805b, 805c, 805d, and 805e that are ready for placement of one or more advertisements or promotions thereon. The conveyor 801 can be of a variety of types known to those of skill in the art, such as a conveyor belt, a series of rolling bars, etc. Conveyor 801 may also include means for varying and controlling the movement and speed of packages 805 through 805e on the conveyor. Packages 805a through 805e may be of a variety of shapes and are not limited to the shapes illustrated in the figures. The packages can travel along the conveyor 801 in the direction of arrow 820, where they are scanned by scanner 803.

The scanner 803 may scan passing packages to extract package information. Scanner 803 may be any type of scanner operable to extract information from packages such as text, labels, barcodes, RFID, etc. In one embodiment, scanner 803 may also include means for scanning and detecting the shape and orientation of a package. The shape and orientation information of a package can be used by print and apply station 813 to aid in the proper placement or application of advertisement information on each package. Scanned information regarding one or more recipient-bound packages may be received by warehouse management controller 807, which may then either transmit the scanned information to or retrieve promotion data associated with the scanned information from kiosk 809. In addition, warehouse management controller 807 may also receive the time of the packages were scanned.

Promotion data regarding one or more promotions targeted to the one or more recipients is received and stored at promotion kiosk 809, where they may be ready prior to retrieval for placement on packages. The promotion data may be received at promotion kiosk 809 from a promotion targeting system (not illustrated). A promotion targeting system may be operated by a third party service or provider who matches unique advertisements or promotions to targeted recipients. Information such as recipient names, addresses, identifiers, or any other information useful in identifying the one or more recipients may be transmitted to the promotion targeting system upon receiving order requests from the recipients. The matching may be performed and/or transmitted to the promotion kiosk 809 prior to the packages associated with the recipients entering conveyor 801 (e.g., the night before).

Targeted promotions may be selected based on customer demographics, as discussed above, and purchase history. Profiles associated with the one or more recipients may be retrieved. The profiles may be generated by the promotion targeting system or from information provided by package handling and distribution systems. Information stored in the profiles may include geographic, demographic, socio-economic and purchasing behavior information associated with the one or more recipients. In some embodiments, it may be determined that there are no available promotions for some of the scanned packages or only selective packages are to have promotions.

A targeted promotion from a third party advertiser may target recipients with certain parameters, for example, being located in a specific geographic region and belonging to a certain demographic group. Parameters of the one or more recipients may be determined from the package information and the recipient information. The promotions may be retrieved using decision trees, graphs or models to match specific promotions with specific customers or packages. A decision tree is a decision support tool that uses a tree-like graph or model of decisions and their possible consequences, including chance event outcomes, resource costs, and utility. A decision tree may be used where the expected values (or expected utility) of competing alternatives are calculated. A decision tree includes splitting paths where each node indicates a decision made on, for example, the above-mentioned geographic, demographic, socio-economic and purchasing behavior. Analysis can take into account the decision maker's (the third party advertiser) preference or utility function. In this example, the preference or utility function pertains to the third party advertiser's targeting parameters.

Warehouse management controller 807 may retrieve the promotions from promotion kiosk 809 and transmit the promotions to a print controller 811. In another embodiment, promotion kiosk 809 may send the promotion data directly to print controller 811. Print controller 811 may store the promotion data and receive from warehouse management controller 807 instructions for spooling the promotion data to print and apply station 813. Print controller 811 may be a print server or any processing logic configured to spool and manage print jobs to print and apply station 813. Warehouse management controller 807 is configured to manage the conveyor 801, scanner 803, and print and apply station 813 to operate in conjunction with each other. Each package is tracked by warehouse management controller 807 throughout the conveyor 801.

In one embodiment, packages are received into conveyor 801 in serial fashion, and warehouse management controller 807 notes the order in which packages should arrive at a given location within conveyor 810. Warehouse management controller 807 may also determine the precise location of any given package at any time. In another embodiment, warehouse management controller 807 may also include means for determining where a package will be in a future time and/or when a package will arrive at a predetermined location according to a speed conveyor 801 is running. In one embodiment, warehouse management controller 807 may communicate with conveyor 801 to run at a speed set according to the warehouse management controller 807. The warehouse management controller 807 may require running conveyor 801 at managed speeds for applying advertisements or promotions on packages by print and apply station 813, which includes running conveyor 801 at a speed associated with the speed of print and apply station 813.

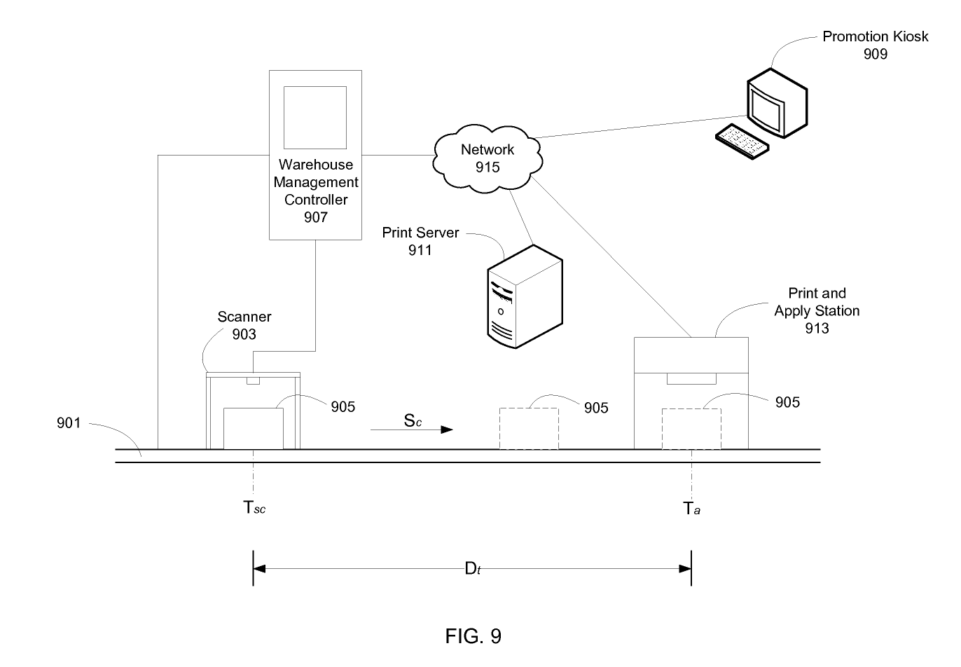

According to one embodiment, specific promotion data designated for a specific package is spooled to the print and apply station 813 for a print job corresponding to the designated package. The promotion data is spooled to the print and apply station 813 prior to the package's arrival. A package's time of arrival at print and apply station 813 may be determined according to various calculations, equations, and algorithms so as to ensure that the print and apply station 813 is ready to place a specific promotion or advertisement on the specific package. For example, a package's arrival time at print and apply station 813 may be determined based on variables such as conveyor speed, promotion retrieval time, spool time, and promotion placement time, etc. Methods for determining a package's arrival time at print and apply station 813 are described in further detail with respect to the description of FIG. 9. In another embodiment, warehouse management controller 807 may vary the speed of conveyor 801 if it determines a delay or print and apply station 813 is not yet ready for promotion placement on a given package.

The print and apply station 813 may further include a scanner to determine a package's time of arrival and location to aid in the placement of a promotion on the package. Alternatively, a scanner unit may be placed on conveyor 801 in a position just prior to where a package reaches the print and apply station 813 that is sufficient enough to determine the imminent arrival of the package to the print and apply station 813. Once a package arrives at print and apply station 813, the station may place a targeted advertisement or promotion onto the package. Placement of an advertisement or promotion may include any one of: printing a promotion directly on a package, printing a promotion on a label and placing the label on a package, and printing a promotion on a blank label placed on a package.

The print and apply station 813 may include any one of: a high-speed black and white and/or color laser printer, a thermal transfer printer, and a high-speed black and white and/or color inkjet printer. However, packages on conveyor 801 travel at a rapid rate and application of a promotion on a given package requires high speed equipment that can be synchronized with conveyor 801. According to one embodiment, the present system advantageously utilizes Memjet technology to print color advertisements on packages moving along on conveyor 801. Using traditional inkjet and even traditional laser printers may be relatively slow and unreliable for use in such an industrial environment. On the other hand, Memjet printers can spool and print quality color advertisements at a much faster rate than traditional inkjet or laser printers. Application of Memjet printers in a conveyor system are described in further detail with respect to the description of FIG. 9.

FIG. 9 presents another diagram of a system for placing advertisements on parcel packages according to one embodiment. The system includes conveyor 901, scanner 903, package 905, warehouse management controller 907, promotion kiosk 909, print server 911, and print and apply station 913. Package 905 is shown moving along conveyor 901 from scanner 905 to print and apply station 913. Conveyor 901, scanner 903 and print and apply station 913 may be controlled either directly or indirectly by warehouse management controller 907. Warehouse management controller 907 may include a display and console useable by a human operator to monitor system status, access reports, diagnose problems, configure operating settings, and manually control operation of conveyor 901, scanner 903, and print and apply station 913.

Information of the packages are scanned at scanner 903 and extracted to warehouse management controller 907 for retrieval of promotion data corresponding to the identified packages from promotion kiosk 909 via network 915. The scanned and extracted information may also include the time of when each of the packages were scanned. Promotion kiosk 909 may be a terminal manned by a human operator or automated via communications from warehouse management controller 907. The promotion kiosk 909 may be configured to upload package recipient information to a promotion targeting system, initiate print jobs, and review ads received from the promotion targeting system. Features, operations, and the interface of promotion kiosk 909 are described in further detail in commonly owned U.S. Patent Application Publication No. 2011/0270681, entitled “SYSTEM AND METHOD FOR TARGETED ADVERTISING ON PARCEL PACKAGES” which is herein incorporated by reference in its entirety.

According to one embodiment, the promotion data is transmitted to printer server 911 from promotion kiosk 909. In another embodiment, promotion data may be transmitted to warehouse management controller 907 where it may manage and feed the promotion data to print server 911, via network 915. Print server 911 may be any device that connects one or more printers (e.g., print and apply station 913) to warehouse management controller 907 over network 915. The print server 911 may support a variety of industry-standard or proprietary printing protocols including, but not limited to, Internet Printing Protocol, Line Printer Daemon protocol, Microsoft Network Printing protocol, NetWare, NetBIOS/NetBEUI, or JetDirect. According to one embodiment, print server 911 may be a dedicated device on the network 915, with LAN connections to one or more printers. In an alternative embodiment, print server 911 may be a networked computer with one or more shared printers. In yet another embodiment, functionality provided by print server 911 may be integrated with other devices such as a wireless router, a firewall, or even print and apply station 913.

The print server 911 can accept print jobs from warehouse management controller 907 and send the print jobs to print and apply station 913, or any other appropriate printer (not illustrated). Printer server 911 may temporarily store the promotion data until a spool command is received. In some embodiments, print jobs sent from warehouse management controller 907 may be automatically spooled. Alternatively, promotion kiosk 909 may send print jobs to printer server 911. The print jobs received from promotion kiosk 909 may be queued on printer server 911 until a spool command from warehouse management controller 907 is received. A spool command may include instructions that identify one or more print jobs corresponding to one or more packages to spool to print and apply station 913. Print jobs may also be batched, in which an entire batch may be spooled in response to a single spool command.

The spool command may be triggered upon a determination that a given package is arriving at print and apply station 913. Determination of the given package's arrival may include calculation of a time of arrival for the given package to print and apply station 913. According to one embodiment, warehouse management controller 907 may utilize a formula for calculating time of arrival such as:

$${T}_{a} = {T}_{sc} + \frac{{D}_{t}}{{S}_{c}}$$

where Tₐ is the time of arrival for a package scanned at time T_{sc} to arrive at print and apply station 913. Tₐ can be roughly calculated by adding the time T_{sc} with a distance to travel from the scanner to a print and apply station Dₜ divided by the speed at which the conveyor is moving S_{c}.

A spool command may be transmitted at a time Tₛₚ such that:

Tₛₚ<Tₐ−(Dₛₚ+Lₙ)

and that print and apply station is ready with promotion data associated with the spool command at time Tₚₐ≦Tₐ, where Tₚₐ=Tₛₚ+Dₛₚ+Lₙ.

A spooling delay Dₛₚ corresponds to a duration of time needed to spool a print job on print and apply station 913. The value of Dₛₚ may vary depending on the size of the print job or promotion data. Network latency Lₙ may be defined as a measure of time delay experienced in the system. The latency may include the delay in transmission of a spool command to arrive at print server 911 and a delay in spool data to arrive at print and apply station 913. Lₙ excludes the amount of time that a destination system spends processing data.

Once promotion data has been spooled to print and apply station 913, the promotion data may be produced as an image or a print. The image or print may be applied to an appropriate package based on the time and order in which the package is scanned by scanner 903, and the determination of the package's arrival time. Print and apply station 913 may receive a sequentially ordered queue of promotion data/print jobs corresponding to the order of which packages were scanned by scanner 903 and print the promotion data on each package according to the order of the queue. Additionally, print and apply station 913 may also include scanner means for detecting when a package has arrived in a “printing zone,” or a location where printing is to occur, of the print and apply station 913, and timing logic configured to assist in the timing of the printing and/or application of promotion data on a package. In one embodiment, print and apply station 913 may include a Memjet printer. A Memjet printer is a fast ink-based printer including a Memjet print head that spans the width of a page or printing surface and prints the entire printing surface in a single pass.

Traditional inkjet printers, especially when printing color images, are notorious slow and cannot be feasibly used in a conveyor environment, such as the one disclosed herein where packages can move at a rate of, for example, 60 parcels per minute. Conventional inkjet printers operate by running a print head carriage back and forth, which is slow and prone to mechanical failure. According to one embodiment, the system is configured to enable placement of color advertisements on packages in an automated parcel distribution environment.

The advertisements or promotions may be printed in color using a high speed page width inkjet printer, such as the Memjet printer. In addition to faster printing speed in terms of physically applying ink to a surface, Memjet printers also provide faster spooling speeds. A controller chip within the Memjet printers include a high-speed print pipeline which runs on dedicated hardware. As such, spooling delay Dₛₚ may be significantly reduced which makes color printing feasible in a conveyor system and even allows for faster conveyor operating speeds. The application of the promotion data to the package may be synchronized with the conveyor speed. According to one embodiment, application of the promotion data utilizes a Memjet printer wherein the Memjet printer speed is synchronized with the conveyor speed. Referring back to the example where packages can move at a rate of 60 parcels per minute on a conveyor, a printer using Memjet technology may be configured to achieve a 60-page-per-minute print speed continuously to match the speed of the conveyor.

Further details regarding Memjet printer technology is discussed in U.S. Pat. No. 7,328,966, entitled “PAGE-WIDTH INKJET PRINTER WITH PRINTHEAD-TRANSFER ROLLER ARRANGEMENT,” U.S. Pat. No. 7,448,734, entitled “INKJET PRINTER CARTRIDGE WITH PAGEWIDTH PRINTHEAD,” and U.S. Pat. No. 7,537,297, entitled “PRINTER CONTROLLER FOR A MEMS-BASED PAGE WIDTH INKJET PRINTER,” which are herein incorporated by reference in their entirety.

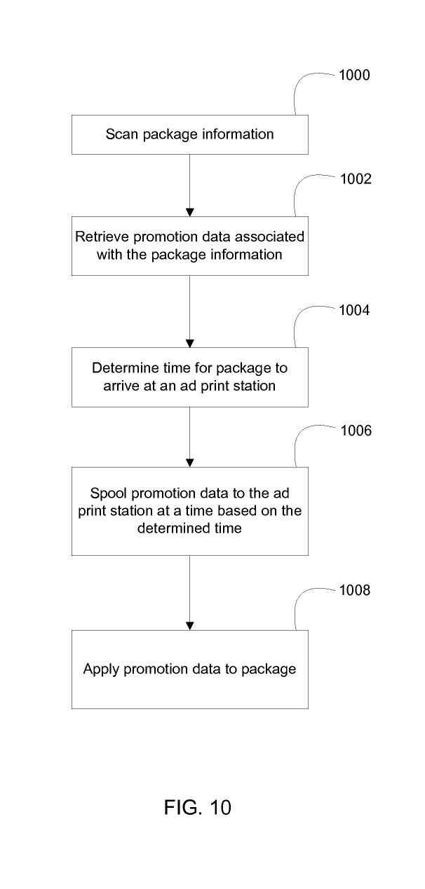

FIG. 10 illustrates a flowchart of a method for placing advertisements on parcel packages according to an embodiment. Packages ready to be prepared for distribution are received on a conveyor and information on the package is scanned, step 1000. The packages may have barcode, text, graphics, or other features on the packages capable of being scanned for extracting information of individuals associated with the packages. Information of the packages are scanned by a scanner and extracted for retrieval of promotion data corresponding to the scanned packages.

In a next step 1002, promotion data associated with the package information is retrieved. Information scanned from the packages may be used to identify individuals and their personal information, such as name, demographics, shopping history, etc. The information can be used to determine promotion data specific to each individual. The promotion data can be configured for transmission to a printer server connected to print and apply stations. A time for a given package to arrive at an ad print station is determined, step 1004. The determined time may be used to control the ad print station (or print and apply station) to operate in sync with the scanned packages entering the conveyor system, to ultimately be able to apply corresponding promotion data to each of the scanned packages.

Promotion data is spooled to the ad print station at a time based on the determined time, step 1006. Print jobs may be received and queued for printing on the ad print station until a spool command is received. The spool command can be triggered and received upon a determination that one or more packages are arriving at the ad print station. Once the promotion data has completed spooling, the ad print station can apply promotion data to packages corresponding to the promotion data, step 1008. Application of promotion data to packages may include using a Memjet printer to either print the promotion data on the packages or print the promotion data on labels and apply the labels to the packages. According to one embodiment, application of the promotion data utilizes a Memjet printer wherein the Memjet printer speed is synchronized with the conveyor speed.

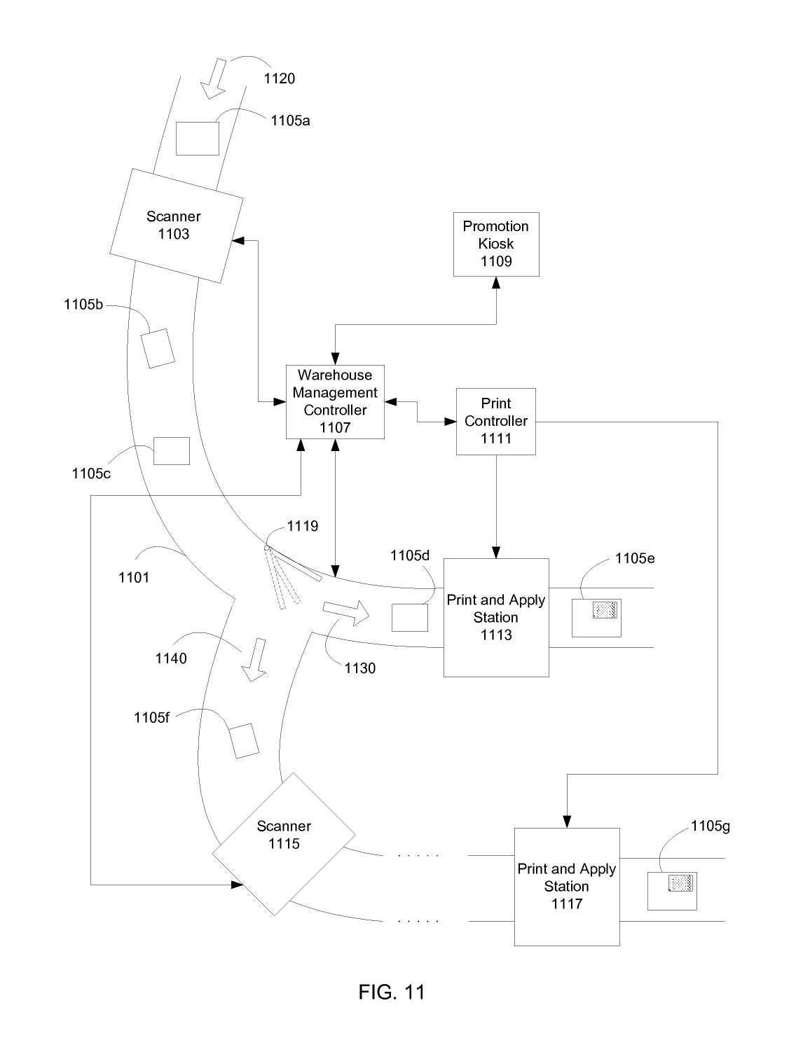

FIG. 11 illustrates a component diagram of a system for placing advertisements on parcel packages according to another embodiment. The diagram of FIG. 11 presents an embodiment where packages may take different paths and promotions are applied to the packages using multiple print and apply stations. Packages 1105a through 1105g are received on conveyor 1101 from the direction of arrow 1120 and are scanned by scanner 1103. Conveyor 1101 includes scanners 1103, 1115 and print and apply stations 1113, 1117 and diverter 1119. Conveyor 1101, scanners 1103, 1115, promotion kiosk 1109, and print controller 1111 are communicatively coupled to warehouse management controller 1107. Warehouse management controller 1107 is also communicatively coupled to print controller 1111 for communication and control of print and apply stations 1113, 1117.

A subset of the packages that are on conveyor 1101 may continue to follow the path of arrow 1130, such as package 1105d, towards print and apply station 1113, which was described with respect to the description of FIG. 8. However, another subset of packages may also be diverted in the direction of arrow 1140 with diverter 1119. Movement of diverter 1119 from a rest position (as shown in solid lines) to an engaged position (dashed lines) is illustrated in FIG. 11 which will diverted a predetermined package to scanner 1115. A package may be diverted based on a print and apply station the package is destined for. A determination is made for each package of where they are destined to by warehouse management controller 1107. The determination may be based on at least one of: different printing capabilities provided by print and apply stations 1113 and 1117, different batches of promotions, size and/or type of print jobs, spooling time, a reject/scanning error, promotion data cannot be retrieved, load balancing, etc. The number of diversions and splits on a conveyor is not limited to the illustration depicted in FIG. 11 and may include multiple conveyor paths, scanners, print and apply stations, and warehouse management controllers.

A package that has gone in the direction of arrow 1140, such as package 1105f, is also scanned by scanner 1115. The scanner 1115 may be configured to scan packages to recalculate arrival times as well as rescanning information from packages that were rejected or where promotion data could not be retrieved. Information from scanner 1115 is received by warehouse management controller 1107 where it may use the information for the retrieval of promotion data from promotion kiosk 1109 for rejected packages and updating a time of arrival for packages approaching print and apply station 1117. In one embodiment, print and apply station 1113 may have different printing configurations or capabilities than of print and apply station 1117. Warehouse management controller 1107 may assign packages to different print and apply stations based on the capabilities of the print and apply stations. For example, some print and apply stations may be designated for color printing while others are designated for black and white printing. In configuration with multiple print and apply stations, print controller 1111 is operable to simultaneously manage multiple print jobs and queues for each print and apply station.

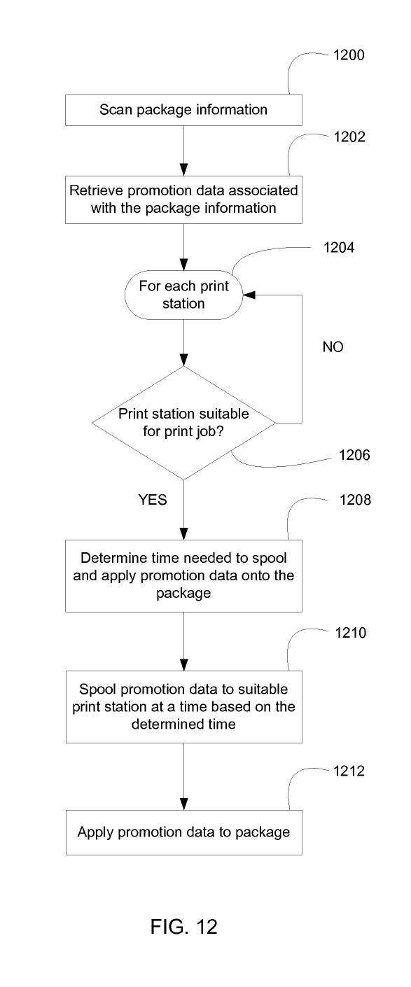

FIG. 12 illustrates a flowchart of a method for selecting print stations for placing advertisements on parcel packages according to one embodiment.

Package information is scanned, step 1200. The package information is extracted and used to retrieve promotion data associated with the package information, step 1202. The promotion data may be associated with a given print job of which may be assigned to one of a plurality of print stations. Print stations are iteratively examined, step 1204, and a determination is made, of whether a given print station is suitable for a print job, step 1206. Various criteria may be used to determine suitability such as, capabilities of print stations, different batches of promotions, size and/or type of print jobs, and spooling time. A print station found to be suitable for the print job may be selected. In another embodiment, a print station may be selected based on load balancing among a plurality of suitable print stations.

A time needed to spool and apply promotion data onto the package is determined, step 1208. The time needed to spool and apply the promotion data may vary based on the type and size of the print job, print station, and other factors such as determining a time Tₛₚ with respect to the discussion of FIG. 9. The determined time may be used in the timing of sending a spool command associated with the promotion data to the print station. In a next step 1210, promotion data is spooled to the suitable print station at a time based on the determined time. According to one embodiment, the promotion data may be spooled to the suitable print station at a time Tₛₚ calculated for a print job of the promotion data to the print station. Print jobs may be received and queued by a print controller or server for spooling to and printing on the ad print station until a spool command is received. The spool command can be triggered based upon a determination that the package is arriving at the ad print station, which may be used to calculate the time Tₛₚ. The print station is readied with the promotion data when the print job has been spooled to the print station. In a next step 1212, the promotion data is applied to the package. The application of the promotion data to the package may be synchronized with the conveyor speed. According to one embodiment, application of the promotion data utilizes a Memjet printer wherein the Memjet printer speed is synchronized with the conveyor speed.

FIGS. 1 through 12 are conceptual illustrations allowing for an explanation of the methods and system discussed herein. It should be understood that various aspects of the embodiments of the present invention(s) could be implemented in hardware, firmware, software, or combinations thereof. In such embodiments, the various components and/or steps would be implemented in hardware, firmware, and/or software to perform the functions described herein. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention(s) to a single embodiment, as other embodiments are possible by way of interchange of some or all of the described or illustrated elements. Moreover, where certain elements of the present invention(s) can be partially or fully implemented using known components, only those portions of such known components that are necessary for an understanding of the present invention(s) are described, and detailed descriptions of other portions of such known components are omitted so as not to obscure the invention(s). In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the methods and systems encompass present and future known equivalents to the known components referred to herein by way of illustration.

The foregoing description of the specific embodiments will so fully reveal the general nature of the invention(s) that others can, by applying knowledge within the skill of the relevant art(s) (including the contents of the documents cited and incorporated by reference herein), readily modify and/or adapt for various applications such specific embodiments, without undue experimentation, without departing from the general concept of the present invention(s). Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention(s) have been described above, it should be understood that they have been presented by way of example, and not limitation. It would be apparent to one skilled in the relevant art(s) that various changes in form and detail could be made therein without departing from the spirit and scope of the invention(s). Thus, the present invention(s) should not be limited by any of the above-described exemplary embodiments, but should be defined only in accordance with the following claims and their equivalents.

What is claimed is:

1. A method for placing targeted advertisements on parcel packages moving on a conveyor, the method comprising:
electronically scanning, via a processing device, information regarding one or more packages to be delivered to one or more recipients;
retrieving promotion data regarding one or more promotions targeted to the one or more recipients;
determining an arrival time for the one or more packages to arrive at a print station based on a rate at which the one or more packages are moving on the conveyor;
spooling the promotion data to the print station at a spool time based on the arrival time; and
applying one or more promotion labels associated with the promotion data on the one or more packages at the print station in synchronization with the package movement rate.

2. The method of claim 1, further comprising synchronizing the print station with the package movement rate.

3. The method of claim 1, wherein the print station includes a high-speed printer.

4. The method of claim 1, wherein the print station includes a Memjet printer.

5. The method of claim 1, further comprising synchronizing printing speed of the print station with the package movement rate.

6. The method of claim 1, further comprising synchronizing the conveyor's speed with printing speed of the print station.

7. The method of claim 1, further comprising printing the one or more promotion labels in black and white.

8. The method of claim 1, further comprising printing the one or more promotion labels in color.

9. The method of claim 1, wherein the spool time is before the arrival time.

10. A system for placing targeted advertisements on parcel packages, the system comprising:
a conveyor operable to transport one or more packages at a predetermined speed;
a scanner operable to scan information from the one or more packages to be delivered to one or more recipients;
a processor;
a memory having executable instructions stored thereon that when executed by the processor cause the processor to:
retrieve promotion data regarding one or more promotions targeted to the one or more recipients,
determine an arrival time for the one or more packages to arrive at a print station based on the predetermined speed, and
spool the promotion data to the print station at a spool time based on the arrival time; and
a print station operable to apply one or more promotion labels associated with the promotion data on the one or more packages in synchronization with the predetermined speed.

11. The system of claim 10, wherein the processor is caused to synchronize the print station with the package movement rate.

12. The system of claim 10, wherein the print station includes a high-speed printer.

13. The system of claim 10, wherein the print station includes a Memjet printer.

14. The system of claim 10, wherein the processor is caused to synchronize printing speed of the print station with the package movement rate.

15. The system of claim 10, wherein the processor is caused to synchronize the conveyor's speed with printing speed of the print station.

16. The system of claim 10, wherein the print station is operable to print the one or more promotion labels in black and white.

17. The system of claim 10, wherein the print station is operable to print the one or more promotion labels in color.

18. The system of claim 10, wherein the spool time is before the arrival time.

19. A method for placing targeted advertisements on parcel packages moving on a conveyor, the method comprising:
electronically scanning, via a processing device, information regarding a package to be delivered to a recipient;
retrieving promotion data targeted to the recipient;
selecting a given print station suitable for generating a promotion label associated with the promotion data;
determining an arrival time for the package to arrive at the given print station based on a rate at which the package is moving on the conveyor;
spooling the promotion data to the given print station at a spool time based on the arrival time; and
applying the one or more promotion labels on the package at the given print station in synchronization with the package movement rate.

20. The method of claim 19, wherein selecting the given print station includes determining a suitable print station based on at least one of: capabilities of print stations, promotion data batch, size of a print job associated with the promotion data, type of print job associated with the promotion data, and time required to spool the promotion data.

21. A computer-implemented method for determining and printing targeted advertisements on parcel packages moving on a conveyor, the method comprising:
electronically scanning, via a computer processing device, information regarding one or more packages moving on a conveyor to be delivered to one or more recipients;
determining promotion data regarding one or more promotions targeted to the one or more recipients based on the scanned information regarding the one or more packages; and
printing one or more promotion labels associated with the promotion data on the one or more packages moving on the conveyor.

22. The computer-implemented method of claim 21 wherein the step of printing one or more promotion labels includes printing at a print station in synchronization with a package movement rate of the one or more packages.

23. The computer-implemented method of claim 21 wherein the step of determining promotion data includes using a computer processor driven decision analysis to selectively retrieve promotion data from a computer database.

24. The computer-implemented method of claim 23 wherein the computer database is located remotely from the conveyor used to move the one or more packages.

25. The computer-implemented method of claim 21 further comprising determining an arrival time for the one or more packages to arrive at a print station based on a rate at which the one or more packages are moving on the conveyor.

26. The computer-implemented method of claim 25 further including spooling the promotion data to the print station at a spool time based on the arrival time.

27. The computer-implemented method of claim 26, wherein the spool time is before the arrival time.

28. The computer-implemented method of claim 25, wherein the print station includes a high-speed printer.

29. The computer-implemented method of claim 28, wherein the print station includes a Memjet printer.

30. The computer-implemented method of claim 25, further comprising synchronizing printing speed of the print station with the package movement rate.

31. The computer-implemented method of claim 30, further comprising synchronizing the conveyor's speed with printing speed of the print station.

32. The computer-implemented method of claim 21 further including the step of printing substantially identical promotion labels on at least first and second packages at respective first and second print stations.

33. The computer-implemented method of claim 21, further comprising printing the one or more promotion labels in black and white.

34. The computer-implemented method of claim 21, further comprising printing the one or more promotion labels in color.
